(19) United States
(12) Patent Application Publication
(10) Pub. No.: US 2025/0355830 A1
(43) Pub. Date: Nov. 20, 2025

(54) Mechanism for Emulating Clock Stretching

(71) Applicant: Intel Corporation, Santa Clara, CA (US)

(72) Inventor: Aruni NELSON, Rocklin, CA (US)

(21) Appl. No.: 19/286,383

(22) Filed: Jul. 31, 2025

Related U.S. Application Data
(60) Provisional application No. 63/806,723, filed on May 16, 2025.

(51) Int. Cl. G06F 13/42

(52) U.S. Cl. CPC G06F 13/4291; G06F 2213/0016

(57) ABSTRACT

Examples relate to apparatuses, devices, methods, computer programs and non-transitory computer-readable media for emulating clock stretching. A controller apparatus is configured to communicate with a target apparatus via a bus, and to emulate clock stretching based on requests to start and end clock stretching obtained via an in-band interrupt mechanism. The controller apparatus is configured to pause data or command transmissions to the target apparatus during the emulated clock stretching, and to resume the data or command transmissions to the target apparatus after the emulated clock stretching has ended.

### BACKGROUND

I2C (Inter-Integrated Circuit) is a serial communication protocol developed in the early 1980s. It uses two bidirectional lines: SCL (Serial Clock Line) and SDA (Serial Data Line) to transmit data between integrated circuits. I2C operates at standard speeds of 100 kHz or 400 kHz, though modern implementations can reach up to 5 MHz. It employs a controller-target device architecture where multiple target devices can share the same bus, each identified by a unique address. This protocol has become widely adopted in embedded systems, computer motherboards, and consumer electronics due to its simplicity, reliability, and modest hardware requirements.

I3C (Improved Inter-Integrated Circuit) is a newer communication protocol developed by the MIPI Alliance in 2016 as a successor to I2C. It maintains backward compatibility with I2C while offering significant improvements in performance and features. I3C supports higher data rates, up to 12.5 MHz in standard mode and 33.3 MHz in high-speed mode, reaching up to 100 MHz with multiple data lanes, while requiring less power than I2C. The protocol introduces dynamic addressing, in-band interrupts, and hot-join capability, allowing devices to connect to an active bus. I3C also supports multi-controller operations and includes built-in error detection mechanisms. These enhancements make I3C particularly well-suited for sensor integration in mobile devices, automotive applications, and Internet of Things (IoT) systems.

### BRIEF DESCRIPTION OF THE FIGURES

Some examples of apparatuses and/or methods will be described in the following by way of example only, and with reference to the accompanying figures, in which:

FIG. 1a shows a schematic diagram of an example of a controller apparatus or controller device and of an I3C system or mixed I2C/I3C system comprising the controller apparatus or controller device;

FIG. 1b shows a flowchart of a method for a controller device;

FIG. 2a shows a schematic diagram of an example of a target apparatus or target device and of an I3C system or mixed I2C/I3C system comprising the target apparatus or target device;

FIG. 2b shows a flowchart of a method for a target device;

FIG. 3 shows Table 13 from MIPI's I3C Specification v1.2: Mandatory Data Byte Field Format;

FIGS. 4-1 and 4-2 show Table 14 from MIPI's I3C Specification v1.2, with the proposed implementation for emulating (faking) clock stretching;

FIG. 5 indicates the high-level flow for an I3C Clock Stretching feature for I3C Target Devices on an I3C Bus based on this proposed concept;

FIG. 6 indicates the high-level flow for the I3C Clock Stretching feature for I2C Target Devices on the I3C Bus based on this proposed concept; and.

FIG. 7 shows a new data pattern sequence generated by an I2C Target Device requesting Clock Stretching.

### DETAILED DESCRIPTION

Some examples are now described in more detail with reference to the enclosed figures. However, other possible examples are not limited to the features of these embodiments described in detail. Other examples may include modifications of the features, as well as equivalents and alternatives to the features. Furthermore, the terminology used herein to describe certain examples should not be restrictive of further possible examples.

Throughout the description of the figures, same or similar reference numerals refer to same or similar elements and/or features, which may be identical or implemented in a modified form while providing the same or a similar function. The thickness of lines, layers, and/or areas in the figures may also be exaggerated for clarification.

When two elements A and B are combined using an “or”, this is to be understood as disclosing all possible combinations, i.e., only A, only B, as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an”, and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise”, and/or “comprising”, when used, describe the presence of the specified features, integers, steps, operations, processes, elements, components, and/or a group thereof, but do not exclude the presence or addition of one or more other features, integers, steps, operations, processes, elements, components, and/or a group thereof.

Various examples of the present disclosure relate to a method and apparatus for providing a Software Driven Clock Stretching (SDCS) capability, for example, on an I3C bus.

In the Improved Inter Integrated Circuit (I3C) Bus, both I3C and I2C Target Devices can be connected to the I3C Bus with an I3C Controller. However, the previous technology of the Inter Integrated Circuit (I2C) Bus provides a Clock Stretching capability, where a target I2C device can hold the Serial Clock Line (SCL) low, indicating to the I2C Controller that it needs more time to process the data it received. This prevents the I2C Controller or other I2C devices from driving any data on the I2C Bus. This feature is not available in MIPI's Improved Inter Integrated Circuit (I3C) specification. The I3C Bus does not allow Target Devices control of the SCL.

This brings up the following challenges. First, there is no mechanism defined in MIPI's I3C specification that will allow the I3C Target device to support or use the Clock Stretching feature. Second, there is no mechanism for I2C Target devices on the I3C bus to use clock stretching. Clock Stretching is strictly a feature of the I2C Bus and not a feature on the I3C Bus. Other systems may not support clock stretching on the I3C Bus.

The proposed concept provides Clock Stretching support on the I3C Bus for I3C and I2C Target Devices. It may provide adaptive data transmission on the I3C Bus. The focus of this proposed concept is on system software, I3C Controller Firmware, I3C Target Device Firmware, and I2C Target Device Firmware, which can be used to emulate (i.e., “fake”) the clock stretching feature on the I3C Bus.

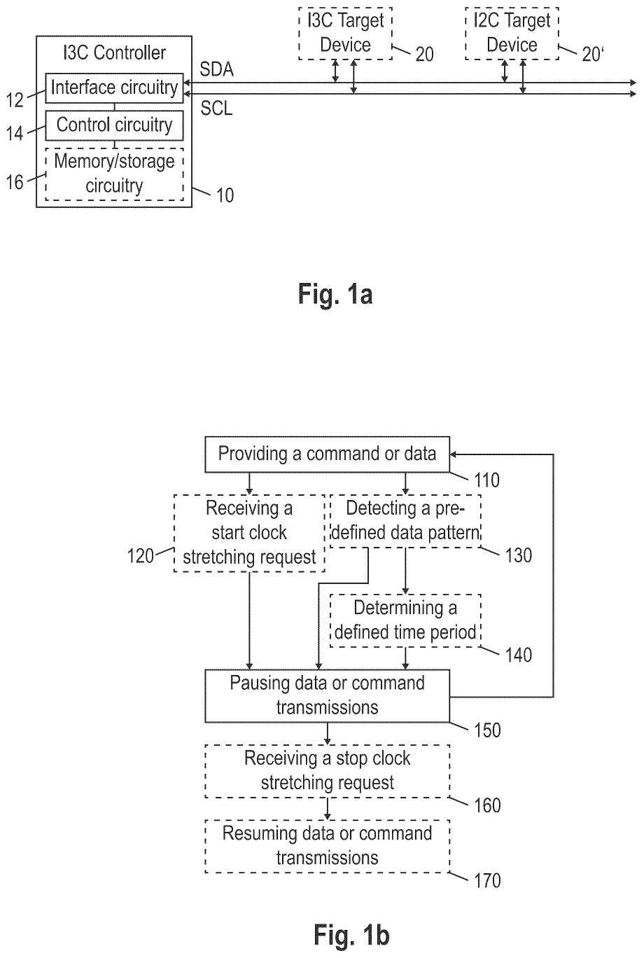

FIG. 1a shows a schematic diagram of an example of a controller apparatus 10 or controller device 10. For example, the controller apparatus 10 or controller device 10 may be a controller for an I3C system or for a mixed I2C/I3C system. FIG. 1a further shows an I3C or mixed I2C/I3C system comprising the controller apparatus 10 or controller device 10 and one or more target apparatuses 20 or target devices 20. The present disclosure also relates to a host device comprising controller apparatus 10 or controller device 10.

The controller apparatus 10 comprises circuitry to provide the functionality of the controller apparatus 10. For example, the circuitry of the controller apparatus 10 may be configured to provide the functionality of the controller apparatus 10. For example, the controller apparatus 10 of FIG. 1a comprises interface circuitry 12, control circuitry 14, and (optional) memory/storage circuitry 16. For example, the control circuitry 14 may be coupled with the interface circuitry 12 and/or with the memory/storage circuitry 16. For example, the control circuitry 14 may provide the functionality of the controller apparatus 10, in conjunction with the interface circuitry 12 (for communicating with other entities inside or outside the controller apparatus 10, such as with one or more target apparatuses 20, 20), and the memory/storage circuitry 16 (for storing information, such as machine-readable instructions). Likewise, the controller device 10 may comprise means for providing the functionality of the controller device 10. For example, the means may be configured to provide the functionality of the controller device 10. The components of the controller device 10 are defined as component means, which may correspond to, or be implemented by, the respective structural components of the controller apparatus 10. For example, the controller device 10 of FIG. 1a comprises means for controlling 14, which may correspond to or be implemented by the processor circuitry 14, means for communicating 12, which may correspond to or be implemented by the interface circuitry 12, (optional) means for storing information 16, which may correspond to or be implemented by the memory or storage circuitry 16. For example, the control circuitry or means for controlling 14 may control the interface circuitry 12 or means for communicating 12 and provide the computational capability of the controller apparatus 10 or controller device 10. In general, the functionality of the control circuitry 14 or means for controlling 14 may be implemented by the control circuitry 14 or means for controlling 14 executing machine-readable instructions, e.g., of a firmware. For example, the functionality of the control circuitry 14 or of the means for controlling 14 may be defined by a firmware of the controller apparatus 10 or controller device. Accordingly, any feature ascribed to the control circuitry 14 or means for controlling 14 may be defined by one or more instructions of a plurality of machine-readable instructions. The controller apparatus 10 or controller device 10 may comprise the machine-readable instructions, e.g., within the memory or storage circuitry 16 or means for storing information 16.

The controller apparatus 10 or controller device 10 is to communicate with a target apparatus via a bus, e.g., via a bus of an I3C or mixed I2C/I3C system/communication network. The controller apparatus 10 or controller device 10 is to emulate clock stretching based on requests to start (Pause Data IBI) and end clock (Resume Data IBI) stretching obtained via an in-band interrupt mechanism. For example, the controller apparatus 10 or controller device may emulate clock stretching in firmware by sending in-band interrupts indicating to hold data patterns according to specific data patterns.

FIG. 1b shows a flowchart of a corresponding method for a controller device (or controller apparatus 10, short controller). The method comprises communicating with one or more target apparatuses via a bus. The method comprises emulating clock stretching (for I3C target apparatuses) based on requests to start and end clock stretching obtained via an in-band interrupt mechanism. For example, the method may further comprise emulating clock stretching for I2C target apparatuses by detecting, on a data line (SDA in FIG. 1a) of the bus, a pre-defined (data) pattern representing a request from a target apparatus to perform clock stretching.

In the following, the features of the controller apparatus 10, of the controller device 10, of the method, and of a corresponding computer program will be discussed in more detail with reference to the controller apparatus 10. Accordingly, in the following, when a target apparatus 20, 20′ is referred to, reference is also made to a corresponding target device 20, 20′. Features introduced in connection with the controller apparatus 10 may likewise be included in the corresponding controller device 10, method, and computer program.

Various examples of the proposed concept provide a concept for emulating clock stretching, e.g., in I3C or mixed I2C/I3C systems. In I2C, clock stretching is a mechanism that allows a target (also “slave”) device to temporarily hold the SCL (clock) line low to force the controller (also “master”) to wait, effectively slowing down the communication. This happens when the target needs more time to process data or prepare a response. In I3C, such a mechanism is not defined. The proposed concept provides a mechanism for emulating clock stretching in I3C or mixed I2C/I3C systems. In this context, an I3C system is a system that only includes I3C devices (one or more I3C controller apparatuses 10/devices and one or more I3C target apparatuses). A mixed I2C/I3C system is a system that includes both I2C and I3C devices, e.g., one or more I3C controller apparatuses 10, one or more I3C target apparatuses 20, and one or more I2C target apparatuses 20′. In mixed I2C/I3C systems, an I3C controller apparatus 10 may be required to support simultaneous operation of I2C and I3C target apparatuses 20, 20′.

In the communication between the controller apparatus 10 and I3C target apparatuses 20, clock stretching is emulated by having the target apparatus requesting clock stretching transmit a Pause Data IBI for starting clock stretching (e.g., a start clock stretching request) and a Resume Data IBI (stop clock stretching request) for stopping clock stretching. Thus, the controller apparatus 10 (e.g., the control circuitry 14) may transmit data or a command to a target apparatus 20, 20′ (e.g., using the interface circuitry 12). Accordingly, the method of FIG. 1b may comprise providing 110 a command or data for the target apparatus 20, 20′. If the target apparatus requires more time to process the data or execute the command, it can request clock stretching to be started by transmitting the Pause Data IBI to the controller apparatus 10. The controller apparatus 10 (e.g., the control circuitry 14 via the interface circuitry 12) may thus receive, from the target apparatus 20, a start clock stretching request (Pause Data IBI) as an in-band interrupt, with the request indicating the start of clock stretching requested by the target apparatus. Accordingly, the method of FIG. 1b may comprise receiving 120, from the target apparatus, a start clock stretching request as an in-band interrupt. Moreover, the controller apparatus 10 (e.g., the control circuitry 14 via the interface circuitry 12) may receive from the target apparatus a Resume Data IBI (stop clock stretching request), indicating the stop of clock stretching requested by the target apparatus. Accordingly, the method of FIG. 1b may comprise receiving 160, from the target apparatus, a stop clock stretching request (Resume Data IBI) as an in-band interrupt, indicating the stop of clock stretching requested by the target apparatus. In I3C, an in-band interrupt (IBI) is a signaling mechanism that allows target apparatuses to notify the controller of events without requiring additional physical pins. These interrupts are transmitted within the regular I3C data stream using special messages called Common Command Codes (CCCs). For example, the IBI with the start clock stretching request and/or stop clock stretching requests may be transmitted/received with an IBI identifier from the reserved range (if the specification is extended) or with an IBI identifier from the vendor specific range, as discussed in connection with FIGS. 4-1 and 4-2.

The respective request is used as a trigger by the controller apparatus 10 to start and stop the clock stretching. In particular, the controller apparatus 10 (e.g., the control circuitry 14) may pause data or command transmissions to the target apparatus in response to the start clock stretching request, and resume data or command transmissions to the target apparatus in response to the stop clock stretching request. Accordingly, the method of FIG. 1b may comprise pausing 150 data or command transmissions to the target apparatus in response to the start clock stretching request. The method may comprise resuming 170 data or command transmissions to the target apparatus in response to the stop clock stretching request. This way, the target apparatus 20 can delay receiving additional data/commands and/or providing a result in response to the data/command until it is ready to do so, thereby emulating clock stretching. In particular, the controller apparatus 10 may emulate clock stretching for I3C target apparatuses based on the requests to start and end clock stretching obtained via the in-band interrupt mechanism.

In some cases, the controller apparatus 10 may have transmitted multiple commands or packets of data to the target apparatus 20. In these cases, it may be ambiguous as to which command or data transmission has triggered the target apparatus 20 to emulate clock stretching. For this reason, the target apparatus 20 may include information regarding the command or data that triggered the target apparatus 20 to emulate clock stretching, such as a time stamp. For example, at least one of the start clock stretching request or the stop clock stretching request may comprise a time stamp indicating when the target apparatus received the last data that triggered the target apparatus to provide the start clock stretching request or the stop clock stretching request. This way, the controller apparatus 10 can resolve the ambiguity.

One focus of I3C is the interoperability between I2C and I3C devices. I2C and I3C interoperability refers to the ability of I3C (Improved Inter-Integrated Circuit) devices to work with legacy I2C devices in the same system. As a result, mixed I2C/I3C systems are possible, i.e., systems (communication networks) that contain both I2C and I3C devices operating together on the same bus. In these systems, I3C controllers can communicate with both I3C and I2C devices, while I2C devices can participate in the system without requiring modifications. While I2C target apparatuses 20′ are inherently able to use clock stretching in I2C systems, this is not possible in mixed I2C/I3C systems, as the I2C target apparatus is unable to “stop the clock,” i.e., hold the clock line.

Therefore, in mixed I2C/I3C systems or communication networks, I2C target apparatuses 20′ may also emulate clock stretching. For this, after the controller apparatus 10 (e.g., the control circuitry 14 via the interface circuitry 12) has provided a command or data for the target apparatus, the I2C target apparatuses 20′ may transmit a specific pattern, such as the I2C target apparatus address followed by 1′b1, to indicate that it wants to perform emulated clock stretching. Accordingly, the controller apparatus 10 (e.g., control circuitry 14) may emulate clock stretching for I2C target apparatuses 20′ by detecting (e.g., via the interface circuitry 12), on a data line, a pre-defined (data) pattern representing a request from a target apparatus to perform clock stretching. Accordingly, the method of FIG. 1b may comprise detecting 130, on the data line, the pre-defined (data) pattern representing a request from a target apparatus 20′ to perform clock stretching. Upon detection of the pre-defined data pattern, the controller apparatus 10 (e.g., control circuitry 14) may pause data or command transmissions to the target apparatus for a defined time period. Accordingly, the method may comprise pausing 150 data or command transmissions to the target apparatus in response to the pre-defined data pattern.

In contrast to I3C target apparatuses 20, I2C target apparatuses 20′ might not actively signal that they are ready to stop clock stretching. Instead, a polling-based approach may be used, in which the controller apparatus 10 repeats the latest transmission to the target apparatus until the target apparatus stops responding with the pre-defined data pattern (indicating that no further clock stretching is necessary). Therefore, the defined time period is used, which determines the time at which retransmission of the respective data or command is performed. In other words, the defined time period is a retransmission time period, which is used to repeat providing the latest command or data to the respective target apparatus 20′. Accordingly, the controller apparatus 10 may be configured to repeat providing the command or data for the target apparatus after the defined time period. Similarly, the method of FIG. 1b may comprise repeating providing 110 the command or data for the target apparatus 20′ after the defined time period.

The defined time is not necessarily static; i.e., it may depend both on the target apparatus 20′ at hand and on the command to be performed or data to be processed. For this reason, the controller apparatus 10 may track the time required by the respective I2C target apparatuses 20′ until they cease responding with the pre-defined data pattern and set the defined time accordingly. In other words, the controller apparatus 10 (e.g., control circuitry 14) may determine the defined time period to use for a target apparatus based on previous pre-defined data patterns detected from the target apparatus, and in particular the time interval between the first transmission of the respective command or data (and the corresponding data pattern received from the target apparatus 20′) and the first successful transmission of the command or data (that did not result in a data pattern being sent by the target apparatus 20′). Accordingly, the method may comprise determining 140 the defined time period to use for a target apparatus.

The interface circuitry 12 or means for communicating 12 corresponds to one or more inputs and/or outputs designed to receive and/or transmit information. This information can be in digital (bit) values according to a specified code, whether exchanged within a module, between different modules, or even between modules of distinct entities. For example, the interface circuitry 12 or means for communicating 12 may include interface circuitry configured to handle the reception and/or transmission of such information.

For example, the control circuitry 14 or means for controlling 14 can be implemented using one or more processing units, processing devices, or any means for processing, such as a processor, a computer, or a programmable hardware component equipped with appropriately adapted software. Thus, the described function of the control circuitry 14 or means for controlling 14 can be executed in software, running on one or more programmable hardware components. These components may include a general-purpose processor, a Digital Signal Processor (DSP), a microcontroller, and more.

In at least some embodiments, the memory or storage circuitry 16, or means for storing information 16, may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

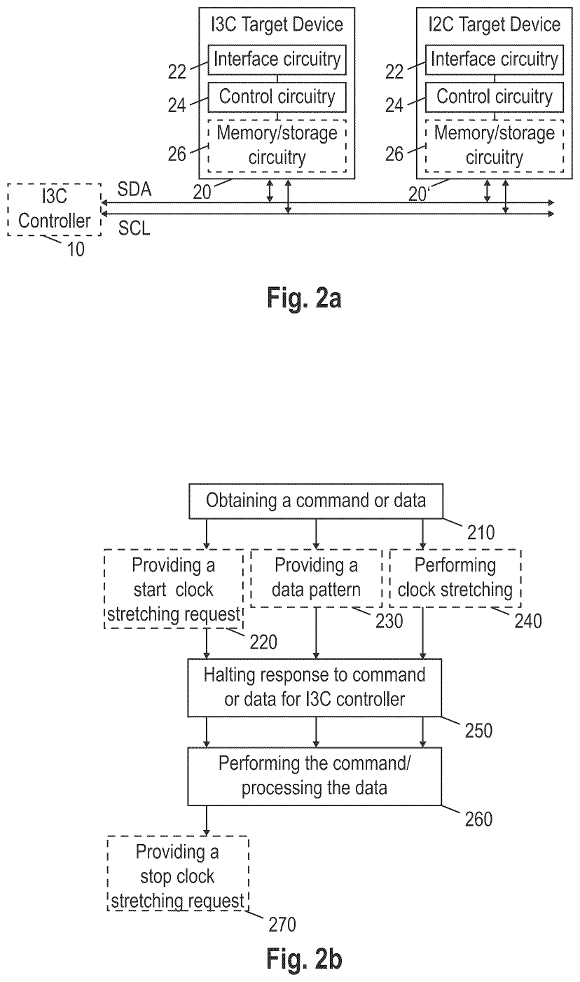

More details and aspects of the controller apparatus 10, controller device 10, method, and computer program are mentioned in connection with the proposed concept or one or more examples described above or below (e.g., FIGS. 2a to 7). The controller apparatus 10, controller device 10, method, and computer program may comprise one or more additional optional features corresponding to one or more aspects of the proposed concept or one or more examples described above or below.

FIG. 2a shows a schematic diagram of an example of target apparatuses 20, 20′ or target devices 20, 20′. In FIG. 2a, two different types of target apparatuses or target devices are shown—an I3C target apparatus 20, and an I2C target apparatus 20′ for use in a mixed I2C/I3C system/communication network. FIG. 2a further shows an I3C or mixed I2C/I3C system comprising the controller apparatus 10 or controller device 10 and one or more target apparatuses 20, 20′ or target devices 20, 20′.

The respective target apparatuses 20, 20′ comprise circuitry to provide the functionality of the target apparatus 20. For example, the circuitry of the target apparatus 20, 20′ may be configured to provide the functionality of the target apparatus 20, 20′. For example, the target apparatus 20, 20′ of FIG. 2a comprises interface circuitry 22, control circuitry 24, and (optional) memory/storage circuitry 26. For example, the control circuitry 24 may be coupled with the interface circuitry 22 and/or with the memory/storage circuitry 26. For example, the control circuitry 24 may provide the functionality of the respective target apparatus 20, 20′, in conjunction with the interface circuitry 22 (for communicating with other entities inside or outside the target apparatus 20, such as with one or more controller apparatuses/controller devices 10), and the memory/storage circuitry 26 (for storing information, such as machine-readable instructions). Likewise, the target device 20 may comprise means for providing the functionality of the target device 20. For example, the means may be configured to provide the functionality of the target device 20. The components of the target device 20 are defined as component means, which may correspond to, or be implemented by, the respective structural components of the target apparatus 20. For example, the target device 20 of FIG. 2a comprises means for controlling 24, which may correspond to or be implemented by the processor circuitry 24, means for communicating 22, which may correspond to or be implemented by the interface circuitry 22, (optional) means for storing information 26, which may correspond to or be implemented by the memory or storage circuitry 26. For example, the control circuitry or means for controlling 24 may control the interface circuitry 22 or means for communicating 22 and provide the computational capability of the target apparatus 20 or target device 20. In general, the functionality of the control circuitry 24 or means for controlling 24 may be implemented by the control circuitry 24 or means for controlling 24 executing machine-readable instructions, e.g., of a firmware. For example, the functionality of the control circuitry 24 or of the means for controlling 24 may be defined by a firmware of the target apparatus or target device. Accordingly, any feature ascribed to the control circuitry 24 or means for controlling 24 may be defined by one or more instructions of a plurality of machine-readable instructions. The target apparatus 20 or target device 20 may comprise the machine-readable instructions, e.g., within the memory or storage circuitry 26 or means for storing information 26.

As outlined above, in FIG. 2a, two different types of target apparatuses or target devices are shown—an I3C target apparatus/device 20 (for an I3C system/communication network or mixed I2C/I3C system/communication network), and an I2C target apparatus/device 20′ for use in a mixed I2C/I3C system/communication network. Both target apparatuses/devices 20, 20′ communicate with one or more controller apparatuses/devices 10 via a bus. The I3C target apparatus/device 20 (e.g., the control circuitry 24 or means for controlling 24) is to emulate clock stretching by providing (e.g., via interface circuitry 22 or means for communicating 22) requests to start and end clock stretching via an in-band interrupt mechanism. The I2C target apparatus/device 20′ (e.g., the control circuitry 24 or means for controlling 24) is to emulate clock stretching by providing (e.g., via interface circuitry 22 or means for communicating 22) a pre-defined data pattern on a data line of the bus.

FIG. 2b shows a flowchart of a corresponding method for a target device (or target apparatus). In the case of the target device/apparatus being an I3C target device/apparatus, the method comprises emulating clock stretching by providing requests to start and end clock stretching via an in-band interrupt mechanism. In the case of the target device/apparatus being an I2C target device/apparatus for use in a mixed I2C/I3C system/communication network, the method comprises emulating clock stretching by providing a pre-defined data pattern on a data line of the bus.

In the following, the features of the target apparatuses 20, 20′, of the target devices 20, 20′, of the method, and of a corresponding computer program will be discussed in more detail with reference to the target apparatuses 20, 20′. Accordingly, in the following, when reference is made to a controller apparatus 10, reference is also made to a corresponding controller device 10. Features introduced in connection with the target apparatuses 20, 20′ may likewise be included in the corresponding target device 20, 20′, method, and computer program.

In the following, first, the proposed procedure is outlined for the I3C target apparatus 20, and is followed by the proposed procedure for the I2C target apparatus 20′.

In case of the I3C target apparatus 20, clock stretching is emulated by the I3C target apparatuses providing requests (e.g., according to the I3C communication protocol or an extension thereof) to start and end clock stretching via an in-band interrupt mechanism. For example, the I3C target apparatus 20 (e.g., the control circuitry 24) may, after obtaining/receiving a command or data to be processed by the controller apparatus 10, determine that it requires more time before it can perform the command or process the data. For example, the target apparatus 20 (e.g., the control circuitry 24, via the interface circuitry 22) may be configured to emulate clock stretching if the target apparatus is temporarily unable to process or react to data or a command from the controller apparatus 10. For example, this may be the case if the control circuitry 24/target apparatus 20, 20′ determines that the command cannot be performed or the data cannot be processed within the time period in which the controller apparatus 10 expects an acknowledgement of the command or data. In this case, the target apparatus 20 (e.g., the control circuitry 24) provides/transmits (e.g., via the interface circuitry 22) a start clock stretching request (Pause Data IBI) as an in-band interrupt to indicate the start of clock stretching requested by the target apparatus 20. Accordingly, the method of FIG. 2b may comprise obtaining 210 a command or data from the controller apparatus 10 and providing 220 the start clock stretching request to the controller apparatus 10. Then, the target apparatus 20 halts a response to the command or data for the I3C controller. Accordingly, the method of FIG. 2b comprises halting 250 the response to the command or data for the I3C controller.

In the meantime, the controller apparatus 20 (e.g., the control circuitry 20) may also perform the command and/or process the data, as per the instructions received from the controller apparatus 10. Accordingly, the method may comprise performing the command and/or processing the data 260. When the target apparatus 20 has finished performing the command and/or processing the data, it provides a corresponding stop clock stretching request (Resume Data IBI) to the controller apparatus 10. In other words, the target apparatus 20 (e.g., the control circuitry 24) provides/transmits (e.g., via the interface circuitry 22) a stop clock stretching request as an in-band interrupt, to indicate the stop of clock stretching requested by the target apparatus. Accordingly, the method of FIG. 2b may comprise providing 270 the stop clock stretching request. Then, the controller apparatus 10 can assume that it is safe to transmit subsequent commands/data to the target apparatus.

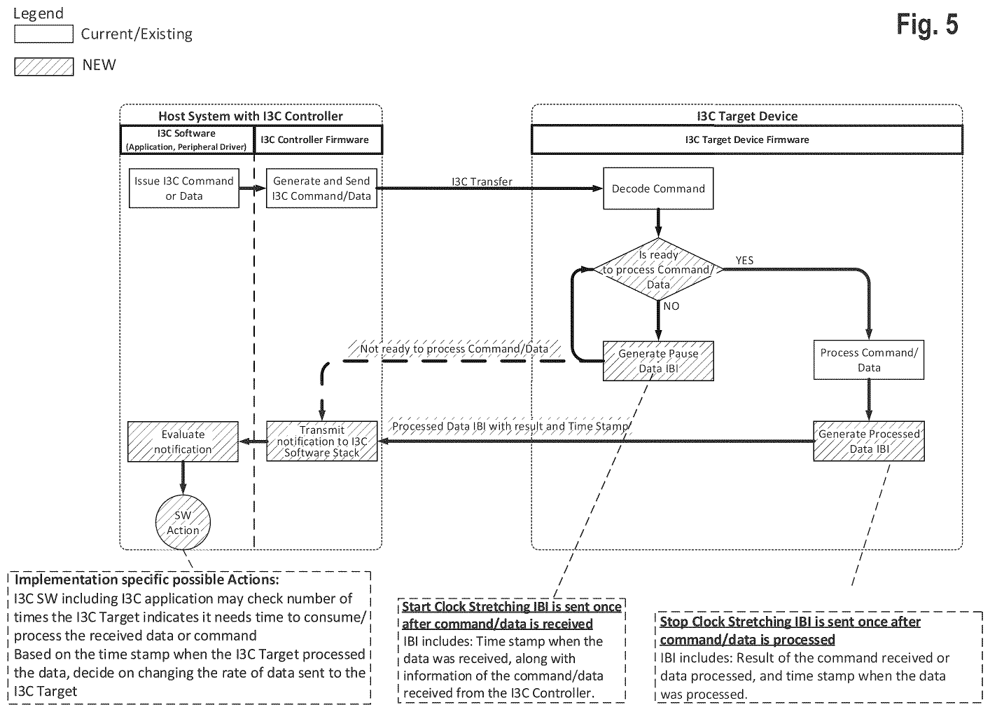

An example of the operation of the target apparatus 20 is provided in connection with FIG. 5.

As discussed in connection with the controller apparatus 10, in some cases, it may be ambiguous, from the controller apparatus' point of view, which command or data has triggered the target apparatus 20 to send the start clock stretching request. Therefore, the target apparatus 20 may include information in the start clock stretching request (or stop clock stretching request) that lets the controller apparatus 10 know whether a command or data needs to be triggered. This data can be inserted into the start clock stretching request and/or the stop clock stretching request. In other words, at least one of the start clock stretching request or the stop clock stretching request may comprise a time stamp of when the target apparatus received the last data that triggered the target apparatus to provide the start clock stretching request (or the stop clock stretching request). This way, the ambiguity on the part of the controller apparatus 10 can be resolved, which may lead to fewer retransmissions being required.

In case of the I2C target apparatus 20′, two scenarios may be distinguished-a first scenario, in which the I2C target apparatus 20′ operates in an I2C system/communication network, and a second scenario, in which the I2C target apparatus 20′ operates in a mixed I2C/I3C communication network. In the first scenario, the I2C target apparatus 20′ (e.g., the control circuitry 24, via the interface circuitry 22) may perform “real” clock stretching by manipulating the clock line (SCL, serial clock). In other words, the target apparatus 20′ may perform clock stretching if the target apparatus is used in an I2C system, for example, if the target apparatus 20′ is temporarily unable to process or react to data or a command from the controller apparatus 10. Accordingly, the method of FIG. 2b may comprise, after obtaining 210 a command or data from the controller apparatus 10, performing 240 clock stretching. Then, the target apparatus 20 halts a response to the command or data for the I3C controller. Accordingly, the method of FIG. 2b comprises halting 250 the response to the command or data for the I3C controller.

In the second scenario, the I2C target apparatus 20′ may merely emulate clock stretching by providing the pre-defined data pattern on a data line. As outlined in connection with FIGS. 1a and/or 1b, this pre-defined data pattern may include the device address of the target apparatus 20′ as well as a pre-defined bit or bit sequence, such as 1′b1, indicating that the target apparatus 20′ desires to start emulating clock stretching. For example, the I3C target apparatus 20′ (e.g., the control circuitry 24) may, after obtaining/receiving a command or data to be processed by the controller apparatus 10, determine that it requires more time before it can perform the command or process the data. For example, the target apparatus 20′ (e.g., the control circuitry 24, via the interface circuitry 22) may be configured to emulate clock stretching if the target apparatus is temporarily unable to process or react to data or a command from the controller apparatus 10, by transmitting the pre-defined data pattern on the data line (SDA), in contrast to the “real” clock stretching, where the target apparatus 20 uses the clock line to indicate the start (and end) of clock stretching. Accordingly, the method of FIG. 2b may comprise, after obtaining/receiving 210 a command or data from the controller apparatus 10, providing 230 the pre-defined data pattern on the data line. Then, the target apparatus 20 halts a response to the command or data for the I3C controller. Accordingly, the method of FIG. 2b comprises halting 250 the response to the command or data for the I3C controller.

This pre-defined data pattern is recognized by the controller apparatus 10 as a trigger to start emulating clock stretching with respect to the target apparatus 20′. The controller apparatus 10 may then retry providing the command or data until the target apparatus 20′ does not respond with the pre-defined data pattern, which is interpreted as an end to the emulated clock stretching. Thus, the target apparatus 20′ may, after obtaining/receiving the command or data a second time (or third time), determine whether additional time is required and respond with the pre-defined data pattern if additional time is required.

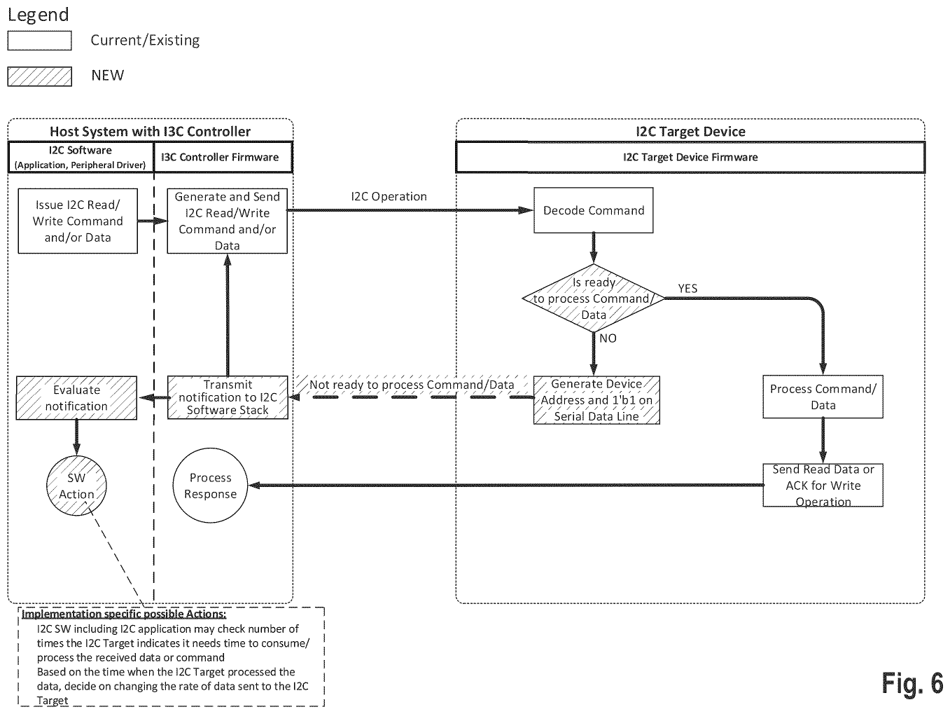

An example of the operation of the target apparatus 20′ is provided in connection with FIG. 6.

The interface circuitry 22 or means for communicating 22 corresponds to one or more inputs and/or outputs designed to receive and/or transmit information. This information can be in digital (bit) values according to a specified code, whether exchanged within a module, between different modules, or even between modules of distinct entities. For example, the interface circuitry 22 or means for communicating 22 may include interface circuitry configured to handle the reception and/or transmission of such information.

For example, the control circuitry 24 or means for controlling 24 can be implemented using one or more processing units, processing devices, or any means for processing, such as a processor, a computer, or a programmable hardware component equipped with appropriately adapted software. Thus, the described function of the control circuitry 24 or means for controlling 24 can be executed in software, running on one or more programmable hardware components. Such components may include a general-purpose processor, a Digital Signal Processor (DSP), a microcontroller, and others.

In at least some embodiments, the memory or storage circuitry 26 or means for storing information 26 may comprise at least one element of the group of a computer readable storage medium, such as an magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the target apparatus 20, target device 20, method, and computer program are mentioned in connection with the proposed concept or one or more examples described above or below (e.g., FIGS. 1a to 1b, 3 to 7). The target apparatus 20, target device 20, method, and computer program may comprise one or more additional optional features corresponding to one or more aspects of the proposed concept or one or more examples described above or below.

In the following, an example implementation of the proposed concept is discussed. For example, the proposed concept may include one or more of the following: (1) New field definitions in the vendor-defined or reserved fields within the Mandatory Data Byte fields of I3C In-Band Interrupts (IBI) of MIPI's I3C Specification are proposed to indicate Clock Stretching Start (Pause Data IBI) and Clock Stretching Stop (Resume Data IBI) for I3C Target Devices (i.e., the start clock stretching request and the stop clock stretching request). (2) New logic may be provided in the I3C Controller (e.g., the controller apparatus 10 or controller device 10 of FIG. 1a) firmware to recognize the new field definitions in the Mandatory Data Byte of the IBI to pause command and data transmission to the I3C Target Device that issues the IBI for starting and stopping the Clock Stretching feature. (3) New logic in the I3C Target Device (e.g., the target apparatus 20 or target device 20 of FIG. 2a) firmware to generate the IBI associated with I3C Clock Stretching. (4) A new data pattern (i.e., the pre-defined data pattern) generated by an I2C Target Device (e.g., the target apparatus 20′ or target device 20′) to indicate a request for Clock Stretching. (5) New logic in the I3C Controller (e.g., the controller apparatus 10 or controller device 10 of FIG. 1a) firmware to recognize the new data pattern from the I2C Target Device indicating a request for Clock Stretching and pause command and data transmission to the I2C Target Device. (6) New logic in the I2C Target Device (e.g., the target apparatus 20′ or target device 20′) firmware to generate the I3C Clock Stretching data pattern (i.e., the pre-defined data pattern).

A user interface may be provided to allow a user to configure the use of the I3C Clock Stretching feature in a system. Applications and tools may provide support for the I3C Clock Stretching feature. Warnings and notifications may be provided on systems or devices which indicate that an I3C or I2C Target device is using I3C clock stretching.

This proposed concept addresses one of the key drawbacks of the MIPI-defined I3C Bus, which is clock stretching. This proposed concept defines a method and apparatus for an I3C Target Device, as well as an I2C Target Device, to generate a request for clock stretching on an I3C Bus.

This proposed concept uses one or more of the following: The proposed concept may use new field definitions in the vendor-defined or reserved fields in the Mandatory Data Byte fields of I3C In-Band Interrupts (IBI) of MIPI's I3C Specification to indicate Clock Stretching Start and Clock Stretching Stop. For example, a new I3C In-band Interrupt (IBI) may be defined to indicate the request for I3C bus clock stretching generated by the I3C Target Device. This IBI may include the Mandatory Data Byte providing additional details associated with the I3C Clock Stretching. It may indicate Start I3C clock stretching or indicate Stop I3C clock stretching. Optionally, additional 4 bytes of IBI data may be provided, which may include the time stamp of when the I3C Target received the last data that required it to request start of I3C Clock Stretching and/or the time stamp of when the I3C Target processed the last data that required it to request stop of I3C Clock Stretching.

The proposed concept may provide new logic in the I3C Controller firmware to recognize the new field definitions of the Mandatory Data Byte of the IBI to pause command and data transmission to the I3C Target Device that issues the IBI for starting and stopping the Clock Stretching feature. This new logic in the I3C Controller firmware may service the IBI associated with I3C Clock Stretching. The new logic may include pausing any new data or command transmission to the I3C Target Devices that generate the Start I3C Clock Stretching (Pause Data IBI) IBI. It may include resuming new data or command transmission to the I3C Target Devices that generate the Stop I3C Clock Stretching (Resume Data IBI) IBI. It may include adjusting the data rate for this I3C Target Device.

The proposed concept may provide new logic in the I3C Target Device firmware to generate the IBI associated with I3C Clock Stretching. This may include the ability to generate the mandatory data byte indicating the start or stop of I3C Clock Stretching. This may additionally, or alternatively, include the ability to generate and send a timestamp as the additional data bytes associated with the IBI for Clock Stretching.

The proposed concept may further provide the generation of a new data pattern from the I2C Target Device to indicate a request for Clock Stretching. The proposed concept may provide new logic in the I3C Controller Firmware to recognize the new data pattern from the I2C Target Device, indicating a request for Clock Stretching, and pause command and data transmission to the I2C Target Device. Based on subsequent commands to this I3C Target Device, the I3C Controller can determine the rate at which it should send commands and data to this I2C Target Device.

The proposed concept may provide new logic in the I2C Target Device firmware to generate the Data Pattern (I2C Target Device Address followed by 1′b1 after it receives a START condition and its Device Address from the I3C Controller) described in this proposed concept, to indicate a request for Clock Stretching.

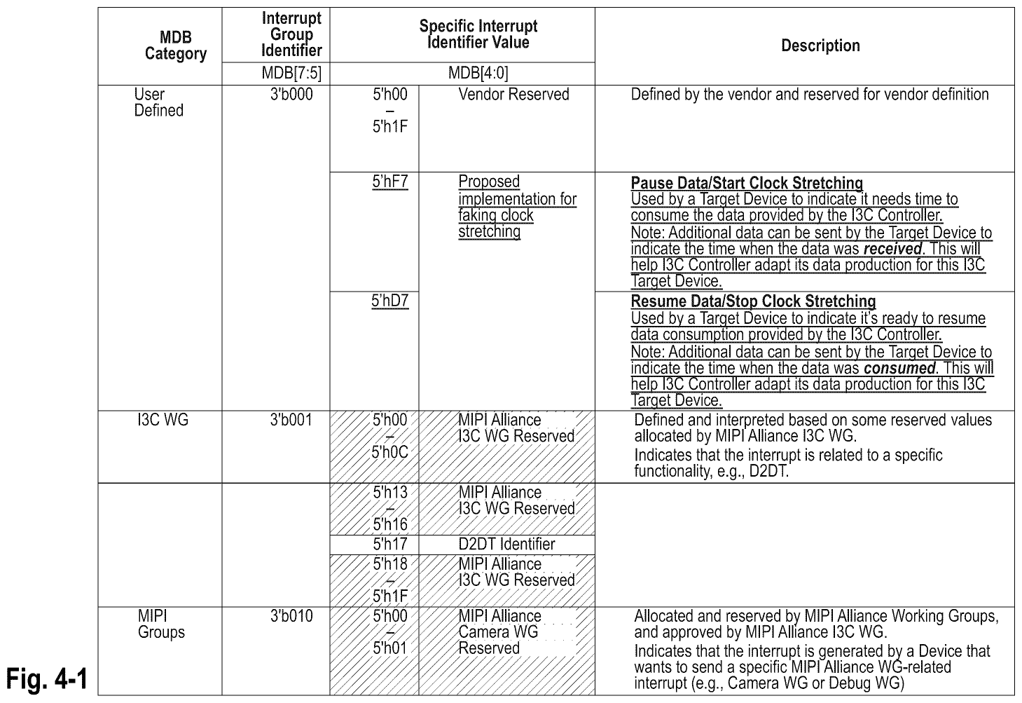

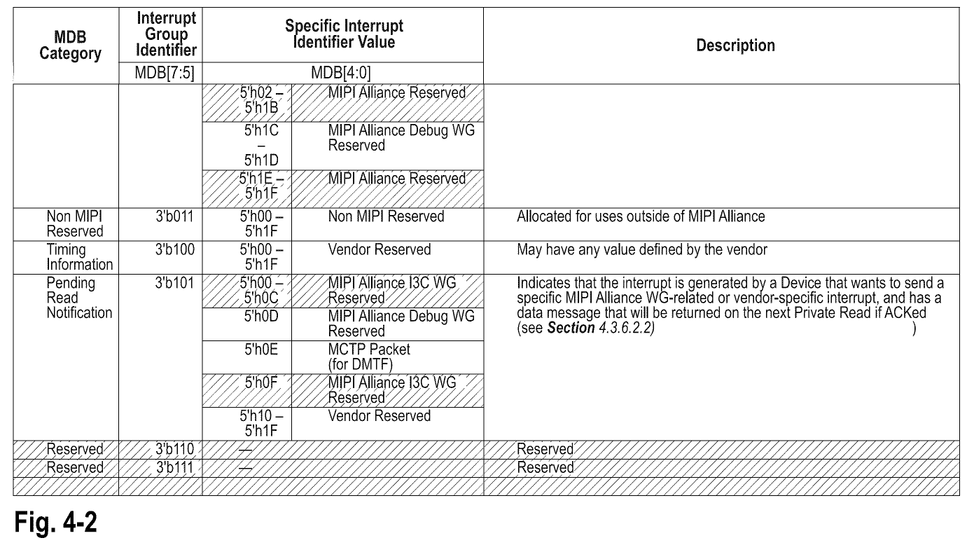

The proposed concept can be included in the I3C specification, where the MIPI reserved IBI field values can be used. Alternatively, the proposed concept may be used as a vendor-specific mechanism for generating and handling I3C Clock Stretching by using the user-defined fields in the I3C specification. Fields to be used for this proposed concept are indicated in underlined text in the table shown in FIG. 4 (FIGS. 4-1 and 4-2).

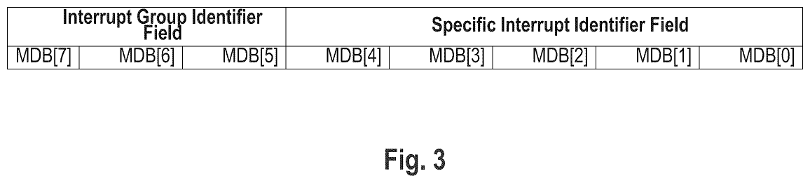

In the following, an example of Clock Stretching for an I3C Target Device is given. For example, the Mandatory Data Byte may provide the Controller with additional information about the event that has happened. It is divided into two fields as shown in Table 13 of MIPI's I3C Specification v1.2, shown in FIG. 3. FIG. 3 shows Table 13 from MIPI's I3C Specification v1.2: Mandatory Data Byte Field Format. It includes the Interrupt Group Identifier, in the three most significant bits: MDB [7:5]. Values for the Interrupt Group Identifier are defined by the MIPI Alliance I3C WG for different use cases. It further includes the Specific Interrupt Identifier, which are the five least significant bits: MDB [4:0].

FIGS. 4-1 and 4-2 show Table 14 from MIPI's I3C Specification v1.2, with the proposed implementation for emulating (faking) clock stretching being underlined. FIG. 5 indicates the high-level flow for the I3C Clock Stretching feature for I3C Target Devices on the I3C Bus based on this proposed concept.

In FIG. 5, in the host system comprising the I3C controller, the I3C software (application, peripheral driver) issues an I3C command or data to the I3C controller firmware, which generates and sends the I3C command/data (as an I3C operation). On the I3C target device, the I3C target device firmware decodes the command and determines whether it is ready to process the command or data. If yes, the data is processed, and the processed data IBI is generated and transmitted, with a result and time stamp, to the I3C controller firmware, which transmits a notification to the I3C software stack, which evaluates the notification and performs a software action. For example, a stop clock stretching IBI may be sent after the command/data is processed. The IBI may include the result of the command received or the data processed, and the time stamp indicating when the data was processed. If no, the I3C target device firmware generates a pause data IBI and indicates to the I3C controller firmware that it is not ready to process the command/data. For example, a start clock stretching IBI is sent once after the command/data is received. The IBI may include a time stamp indicating when the data was received, along with information on the command/data received from the I3C controller. Again, the I3C controller firmware transmits a notification to the I3C software stack, which evaluates the notification and performs a software action. For example, the software action may include that the I3C software, including an I3C application, checks the number of times the I3C target indicates it needs time to consume/process the received data or command. Based on the time stamp indicating when the I3C target has processed the data, it may decide on changing the rate of data sent to the I3C target.

For example, using 5′hF7 as the 5 least significant bits, the Pause Data request (start Clock Stretching request) may be transmitted. This may be used by the Target Device to indicate it needs time to consume the data provided by the I3C Controller. Additional data can be sent by the Target Device to indicate the time when the data was received. This will help the I3C Controller adapt its data production for this I3C Target Device. Using 5′hD7 as the 5 least significant bits, the Resume Data request (stop Clock Stretching request) may be transmitted.

This may be used by the Target Device to indicate it is ready to resume data consumption provided by the I3C Controller. Additional data can be sent by the Target Device to indicate the time when the data was consumed, which will help the I3C Controller adapt its data production for this I3C Target Device.

In the following, an example of Clock Stretching for I2C Target Devices on an I3C Bus is given. This proposed concept also proposes a Clock Stretching (emulation) feature for I2C Devices on an I3C Bus with new logic in the I2C Target Device firmware. FIG. 6 indicates the high-level flow for the I3C Clock Stretching feature for I2C Target Devices on the I3C Bus based on this proposed concept. In the host system comprising the I3C controller, the I2C software (application, peripheral driver) issues an I3C command or data to the I3C controller firmware, which generates and sends the I3C command/data (as an I2C operation). In the I2C target device, the I2C target device firmware decodes the command and determines whether it is ready to process the command or data. If yes, the data is processed, and the read data is sent, or an ACK (acknowledgement) is sent if the command is a write operation. The I3C controller firmware processes the response. If no, the I2C target device firmware generates the device address and 1′b1 on the serial data line (SDA), indicating to the I3C controller firmware that the I2C target device firmware is not ready to process the command/data. The I3C controller firmware transmits a notification to the I2C software stack, which evaluates the notification and takes a software action. For example, possible software actions may include the I2C software, including the I2C application, checking the number of times the I2C target indicates it needs time to consume/process the received data or command. Based on the time when the I2C target has processed the data, the I2C software may decide on changing the rate of data sent to the I2C target. In addition, the I3C controller firmware generates and sends the I2C read/write command and/or data again (after the defined time interval).

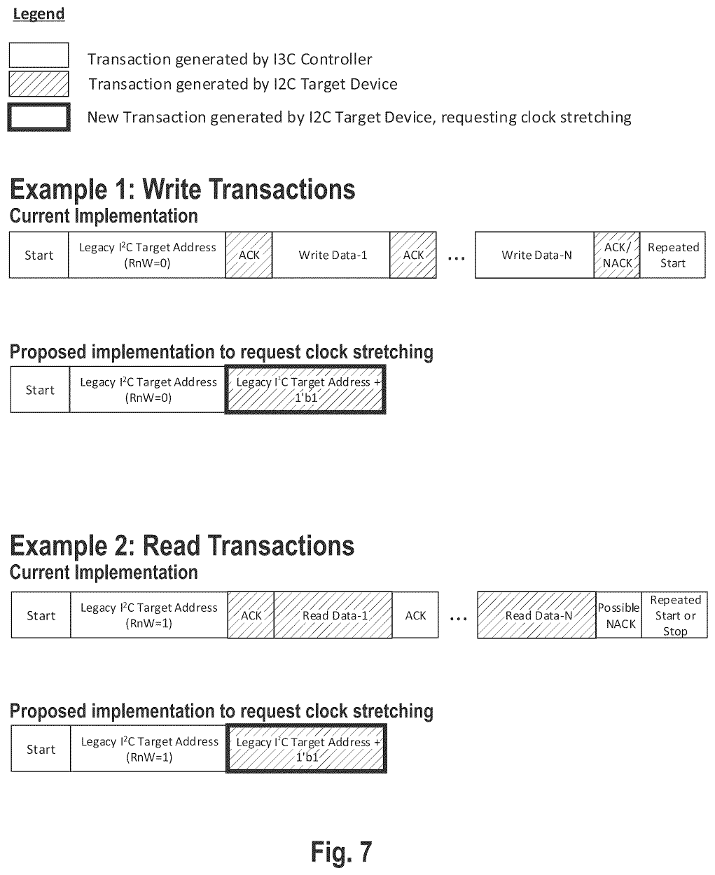

When the I3C Controller issues a START condition followed by the Address of the I2C Target Device, instead of sending the ACK bit, the I2C target device may drive the SDA line with its own Address followed by a 1′b1 bit on the SDA. This would indicate to the I3C Controller that the I2C Target Device intends to start the Clock Stretching. FIG. 7 shows a new Data Pattern for requesting the Clock Stretching feature and adaptive data rate.

Subsequently, if the I3C Controller issues another Read or Write request to the I3C Target Device, if the I2C Target Device needs more time to process the previous command or data, it may drive the SDA line with its own Address followed by a 1-bit 1′b1 on the SDA after the START condition and Address sent by the I3C Controller. If the Target Device is ready to consume the command and data, it will follow the I2C Bus-specified Read/Write Operations.

More details and aspects of the concept for emulating clock stretching are mentioned in connection with the proposed concept or one or more examples described above or below (e.g., FIGS. 1a to 2b). The concept for emulating clock stretching may comprise one or more additional optional features corresponding to one or more aspects of the proposed concept or one or more examples described above or below.

In the following, some examples of the proposed concept are presented:

An example (e.g., example 1) relates to a controller apparatus configured to communicate with a target apparatus via a bus, and emulate clock stretching based on requests to start and end clock stretching obtained via an in-band interrupt mechanism, wherein the controller apparatus is configured to pause data or command transmissions to the target apparatus during the emulated clock stretching, and to resume the data or command transmissions to the target apparatus after the emulated clock stretching has ended.

Another example (e.g., example 2) relates to a previous example (e.g., example 1) or to any other example, further comprising that the controller apparatus is a controller apparatus for an I3C system.

Another example (e.g., example 3) relates to a previous example (e.g., one of the examples 1 or 2) or to any other example, further comprising that the controller apparatus is configured to receive, from a target apparatus, a start clock stretching request as an in-band interrupt, the start clock stretching request indicating the start of clock stretching requested by the target apparatus and receive, from the target apparatus, a stop clock stretching request as an in-band interrupt, the stop clock stretching request indicating the stop of clock stretching requested by the target apparatus.

Another example (e.g., example 4) relates to a previous example (e.g., example 3) or to any other example, further comprising that the controller apparatus is configured to pause data or command transmissions to the target apparatus in response to the start clock stretching request, and resume data or command transmissions to the target apparatus in response to the stop clock stretching request.

Another example (e.g., example 5) relates to a previous example (e.g., one of the examples 1 to 4) or to any other example, further comprising that the controller apparatus is configured to emulate clock stretching for I3C target apparatuses based on the requests to start and end clock stretching obtained via the in-band interrupt mechanism.

Another example (e.g., example 6) relates to a previous example (e.g., example 5) or to any other example, further comprising that the controller apparatus is further configured to emulate clock stretching for I2C target apparatuses by detecting, on a data line, a pre-defined data pattern representing a request of a target apparatus to perform clock stretching.

Another example (e.g., example 7) relates to a previous example (e.g., example 6) or to any other example, further comprising that the controller apparatus is configured to pause data or command transmissions to the target apparatus in response to the pre-defined data pattern for a defined time period.

Another example (e.g., example 8) relates to a previous example (e.g., example 7) or to any other example, further comprising that the controller apparatus is configured to detect the pre-defined data pattern after providing a command or data for the target apparatus.

Another example (e.g., example 9) relates to a previous example (e.g., example 8) or to any other example, further comprising that the controller apparatus is configured to repeat providing the command or data for the target apparatus after the defined time period.

Another example (e.g., example 10) relates to a previous example (e.g., one of the examples 8 or 9) or to any other example, further comprising that the controller apparatus is configured to determine the defined time period to use for a target apparatus based on previous pre-defined data patterns detected from the target apparatus.

Another example (e.g., example 11) relates to a previous example (e.g., one of the examples 1 to 10) or to any other example, further comprising interface circuitry or means for communicating with one or more target apparatuses, and control circuitry or means for controlling to control the interface circuitry and provide the computational capability of the controller apparatus.

Another example (e.g., example 12) relates to a previous example (e.g., example 11) or to any other example, further comprising that the functionality of the control circuitry is defined by a firmware of the controller apparatus.

An example (e.g., example 13) relates to a controller apparatus, comprising interface circuitry for communicating with one or more target apparatuses via a bus, and control circuitry configured to communicate with a target apparatus via the bus, and emulate clock stretching based on requests to start and end clock stretching obtained via an in-band interrupt mechanism, wherein the control circuitry is configured to pause data or command transmissions to the target apparatus during the emulated clock stretching, and to resume the data or command transmissions to the target apparatus after the emulated clock stretching has ended.

Another example (e.g., example 14) relates to a previous example (e.g., example 13) or to any other example, further comprising that the controller apparatus is a controller apparatus for an I3C system.

Another example (e.g., example 15) relates to a previous example (e.g., one of the examples 13 or 14) or to any other example, further comprising that the control circuitry is configured to receive, from a target apparatus, a start clock stretching request as an in-band interrupt, the request indicating the start of clock stretching requested by the target apparatus and receive, from the target apparatus, a stop clock stretching request as an in-band interrupt, the stop clock stretching request indicating the stop of clock stretching requested by the target apparatus.

Another example (e.g., example 16) relates to a previous example (e.g., example 15) or to any other example, further comprising that the control circuitry is configured to pause data or command transmissions to the target apparatus in response to the start clock stretching request, and resume data or command transmissions to the target apparatus in response to the stop clock stretching request.

Another example (e.g., example 17) relates to a previous example (e.g., one of the examples 13 to 16) or to any other example, further comprising that the control circuitry is configured to emulate clock stretching for I3C target apparatuses based on the requests to start and end clock stretching obtained via the in-band interrupt mechanism.

Another example (e.g., example 18) relates to a previous example (e.g., example 17) or to any other example, further comprising that the control circuitry is further configured to emulate clock stretching for I2C target apparatuses by detecting, on a data line, a pre-defined data pattern representing a request of a target apparatus to perform clock stretching.

Another example (e.g., example 19) relates to a previous example (e.g., example 18) or to any other example, further comprising that the control circuitry is configured to pause data or command transmissions to the target apparatus in response to the pre-defined data pattern for a defined time period.

Another example (e.g., example 20) relates to a previous example (e.g., example 19) or to any other example, further comprising that the control circuitry is configured to detect the pre-defined data pattern after providing a command or data for the target apparatus.

Another example (e.g., example 21) relates to a previous example (e.g., example 20) or to any other example, further comprising that the control circuitry is configured to repeat providing the command or data for the target apparatus after the defined time period.

Another example (e.g., example 22) relates to a previous example (e.g., one of the examples 20 or 21) or to any other example, further comprising that the control circuitry is configured to determine the defined time period to use for a target apparatus based on previous pre-defined data patterns detected from the target apparatus.

20 Another example (e.g., example 23) relates to a previous example (e.g., one of the examples 13 to 22) or to any other example, further comprising that the functionality of the control circuitry is defined by a firmware of the controller apparatus.

An example (e.g., example 24) relates to a controller device, comprising means for communicating with one or more target devices via a bus, and means for controlling configured to communicate with a target device via the bus, and emulate clock stretching based on requests to start and end clock stretching obtained via an in-band interrupt mechanism, for example, wherein the means for controlling is configured to pause data or command transmissions to the target apparatus during the emulated clock stretching, and to resume the data or command transmissions to the target apparatus after the emulated clock stretching has ended.

Another example (e.g., example 25) relates to a previous example (e.g., example 24) or to any other example, further comprising that the controller device is a controller device for an I3C system.

Another example (e.g., example 26) relates to a previous example (e.g., one of the examples 24 or 25) or to any other example, further comprising that the means for controlling is configured to receive, from a target device, a start clock stretching request as an in-band interrupt, the request indicating the start of clock stretching requested by the target device and receive, from the target device, a stop clock stretching request as an in-band interrupt, the stop clock stretching request indicating the stop of clock stretching requested by the target device.

Another example (e.g., example 27) relates to a previous example (e.g., example 26) or to any other example, further comprising that the means for controlling is configured to pause data or command transmissions to the target device in response to the start clock stretching request, and resume data or command transmissions to the target device in response to the stop clock stretching request.

Another example (e.g., example 28) relates to a previous example (e.g., one of the examples 24 to 27) or to any other example, further comprising that the means for controlling is configured to emulate clock stretching for I3C target devices based on the requests to start and end clock stretching obtained via the in-band interrupt mechanism.

Another example (e.g., example 29) relates to a previous example (e.g., example 28) or to any other example, further comprising that the means for controlling is further configured to emulate clock stretching for I2C target devices by detecting, on a data line, a pre-defined data pattern representing a request of a target device to perform clock stretching.

Another example (e.g., example 30) relates to a previous example (e.g., example 29) or to any other example, further comprising that the means for controlling is configured to pause data or command transmissions to the target device in response to the pre-defined data pattern for a defined time period.

Another example (e.g., example 31) relates to a previous example (e.g., example 30) or to any other example, further comprising that the means for controlling is configured to detect the pre-defined data pattern after providing a command or data for the target device.

Another example (e.g., example 32) relates to a previous example (e.g., example 31) or to any other example, further comprising that the means for controlling is configured to repeat providing the command or data for the target device after the defined time period.

Another example (e.g., example 33) relates to a previous example (e.g., one of the examples 31 or 32) or to any other example, further comprising that the means for controlling is configured to determine the defined time period to use for a target device based on previous pre-defined data patterns detected from the target device.

Another example (e.g., example 34) relates to a previous example (e.g., one of the examples 24 to 33) or to any other example, further comprising that the functionality of the means for controlling is defined by a firmware of the controller device.

An example (e.g., example 35) relates to a method for a controller device, comprising communicating with a target device via a bus, and emulating clock stretching based on requests to start and end clock stretching obtained via an in-band interrupt mechanism, for example wherein emulating clock stretching comprises pausing data or command transmissions to the target apparatus during the emulated clock stretching, and resuming the data or command transmissions to the target apparatus after the emulated clock stretching has ended.

Another example (e.g., example 36) relates to a previous example (e.g., example 35) or to any other example, further comprising that the method is performed by an I3C controller.

Another example (e.g., example 37) relates to a previous example (e.g., one of the examples 35 or 36) or to any other example, further comprising that the method comprises receiving, from a target device, a start clock stretching request as an in-band interrupt, the request indicating the start of clock stretching requested by the target device and receiving, from the target device, a stop clock stretching request as an in-band interrupt, the stop clock stretching request indicating the stop of clock stretching requested by the target device.

Another example (e.g., example 38) relates to a previous example (e.g., example 37) or to any other example, further comprising that the method comprises pausing data or command transmissions to the target device in response to the start clock stretching request, and resuming data or command transmissions to the target device in response to the stop clock stretching request.

Another example (e.g., example 39) relates to a previous example (e.g., one of the examples 35 to 38) or to any other example, further comprising that the method comprises emulating clock stretching for I3C target devices based on the requests to start and end clock stretching obtained via the in-band interrupt mechanism.

Another example (e.g., example 40) relates to a previous example (e.g., example 39) or to any other example, further comprising that the method further comprises emulating clock stretching for I2C target devices by detecting, on a data line, a pre-defined data pattern representing a request of a target device to perform clock stretching.

Another example (e.g., example 41) relates to a previous example (e.g., example 40) or to any other example, further comprising that the method comprises pausing data or command transmissions to the target device in response to the pre-defined data pattern for a defined time period.

Another example (e.g., example 42) relates to a previous example (e.g., example 41) or to any other example, further comprising that the method comprises detecting the pre-defined data pattern after providing a command or data for the target device.

Another example (e.g., example 43) relates to a previous example (e.g., example 42) or to any other example, further comprising that the method comprises repeating providing the command or data for the target device after the defined time period.

Another example (e.g., example 44) relates to a previous example (e.g., one of the examples 42 or 43) or to any other example, further comprising that the method comprises determining the defined time period to use for a target device based on previous pre-defined data patterns detected from the target device.

Another example (e.g., example 45) relates to a previous example (e.g., one of the examples 35 to 44) or to any other example, further comprising that the method is performed by a firmware of the controller device.

An example (e.g., example 46) relates to a target apparatus configured to communicate with a controller apparatus via a bus, and to emulate clock stretching by providing requests to start and end clock stretching via an in-band interrupt mechanism, e.g., to cause the controller apparatus to pause data or control transmissions to the target apparatus during the emulated clock stretching, and to cause the controller apparatus to resume the data or command transmissions after the emulated clock stretching has ended.

Another example (e.g., example 47) relates to a previous example (e.g., example 46) or to any other example, further comprising that the target apparatus is an I3C target apparatus for an I3C system or a mixed I2C and I3C system.

Another example (e.g., example 48) relates to a previous example (e.g., one of the examples 46 or 47) or to any other example, further comprising that the target apparatus is configured to provide, to indicate the start of clock stretching requested by the target apparatus, a start clock stretching request as an in-band interrupt, and to provide, to indicate the stop of clock stretching requested by the target apparatus, a stop clock stretching request as in-band interrupt.

Another example (e.g., example 49) relates to a previous example (e.g., example 48) or to any other example, further comprising that at least one of the start clock stretching request or the stop clock stretching request comprises a time stamp of when the target apparatus received the last data that triggered the target apparatus to provide the start clock stretching request.

Another example (e.g., example 50) relates to a previous example (e.g., one of the examples 48 or 49) or to any other example, further comprising that at least one of the start clock stretching request or the stop clock stretching request comprises a time stamp of when the target apparatus processed the last data that triggered the apparatus to provide the stop clock stretching request.

Another example (e.g., example 51) relates to a previous example (e.g., one of the examples 46 to 50) or to any other example, further comprising that the start/stop clock stretching requests are transmitted according to the I3C communication protocol.

Another example (e.g., example 52) relates to a previous example (e.g., one of the examples 46 to 51) or to any other example, further comprising interface circuitry or means for communicating for communicating with one or more controller apparatuses, and control circuitry or means for controlling to control the interface circuitry and provide the computational capability of the target apparatus.

Another example (e.g., example 53) relates to a previous example (e.g., example 52) or to any other example, further comprising that the functionality of the target circuitry is defined by a firmware of the target apparatus.

An example (e.g., example 54) relates to a target apparatus configured to communicate with a controller apparatus via a bus, and to emulate clock stretching by providing a pre-defined data pattern on a data line of the bus.

Another example (e.g., example 55) relates to a previous example (e.g., example 54) or to any other example, further comprising that the target apparatus is an I2C target apparatus for a mixed I2C and I3C system.

Another example (e.g., example 56) relates to a previous example (e.g., one of the examples 54 or 55) or to any other example, further comprising that the target apparatus is configured to provide the pre-defined data pattern after receiving a command or data from a controller apparatus.

Another example (e.g., example 57) relates to a previous example (e.g., one of the examples 54 to 56) or to any other example, further comprising that the target apparatus is configured to emulate clock stretching if the target apparatus is temporarily unable to process or react to data or a command by a controller apparatus.

Another example (e.g., example 58) relates to a previous example (e.g., one of the examples 54 to 57) or to any other example, further comprising that the target apparatus is configured to emulate clock stretching if the target apparatus is used in a mixed I2C and I3C system, and to perform clock stretching if the target apparatus is used in a I2C system.

Another example (e.g., example 59) relates to a previous example (e.g., one of the examples 54 to 58) or to any other example, further comprising interface circuitry or means for communicating with one or more controller apparatuses, and control circuitry or means for controlling the control interface circuitry and provide the computational capability of the target apparatus.

Another example (e.g., example 60) relates to a previous example (e.g., example 59) or to any other example, further comprising that the functionality of the target circuitry is defined by a firmware of the target apparatus.

An example (e.g., example 61) relates to a target apparatus, comprising interface circuitry for communicating with one or more controller apparatuses via bus, and control circuitry configured to communicate with a controller apparatus via the bus, and to emulate clock stretching by providing requests to start and end clock stretching via an in-band interrupt mechanism, e.g., to cause the controller apparatus to pause data or control transmissions to the target apparatus during the emulated clock stretching, and to cause the controller apparatus to resume the data or command transmissions after the emulated clock stretching has ended.

Another example (e.g., example 62) relates to a previous example (e.g., example 61) or to any other example, further comprising that the target apparatus is an I3C target apparatus for an I3C system or a mixed I2C and I3C system.

Another example (e.g., example 63) relates to a previous example (e.g., one of the examples 61 or 62) or to any other example, further comprising that the control circuitry is configured to provide, to indicate the start of clock stretching requested by the target apparatus, a start clock stretching request as an in-band interrupt, and to provide, to indicate the stop of clock stretching requested by the target apparatus, a stop clock stretching request as in-band interrupt.

Another example (e.g., example 64) relates to a previous example (e.g., example 63) or to any other example, further comprising that at least one of the start clock stretching request or the stop clock stretching request comprises a time stamp of when the target apparatus received the last data that triggered the target apparatus to provide the start clock stretching request.

Another example (e.g., example 65) relates to a previous example (e.g., one of the examples 63 or 64) or to any other example, further comprising that at least one of the start clock stretching request or the stop clock stretching request comprises a time stamp of when the target apparatus processed the last data that triggered the apparatus to provide the stop clock stretching request.

Another example (e.g., example 66) relates to a previous example (e.g., one of the examples 61 to 65) or to any other example, further comprising that the start/stop clock stretching requests are transmitted according to the I3C communication protocol.

Another example (e.g., example 67) relates to a previous example (e.g., one of the examples 61 to 66) or to any other example, further comprising that the functionality of the target circuitry is defined by a firmware of the target apparatus.

An example (e.g., example 68) relates to a target apparatus comprising interface circuitry for communicating with one or more controller apparatuses via a bus, and control circuitry configured to communicate with a controller apparatus via the bus, and to emulate clock stretching by providing a pre-defined data pattern on a data line of the bus.

Another example (e.g., example 69) relates to a previous example (e.g., example 68) or to any other example, further comprising that the target apparatus is an I2C target apparatus for a mixed I2C and I3C system.

Another example (e.g., example 70) relates to a previous example (e.g., one of the examples 68 or 69) or to any other example, further comprising that the control circuitry is configured to provide the pre-defined data pattern after receiving a command or data from a controller apparatus.

Another example (e.g., example 71) relates to a previous example (e.g., one of the examples 68 to 70) or to any other example, further comprising that the control circuitry is configured to emulate clock stretching if the target apparatus is temporarily unable to process or react to data or a command by a controller apparatus.

Another example (e.g., example 72) relates to a previous example (e.g., one of the examples 68 to 71) or to any other example, further comprising that the control circuitry is configured to emulate clock stretching if the target apparatus is used in a mixed I2C and I3C system, and to perform clock stretching if the target apparatus is used in a I2C system.

Another example (e.g., example 73) relates to a previous example (e.g., one of the examples 68 to 72) or to any other example, further comprising that the functionality of the control circuitry is defined by a firmware of the target apparatus.

An example (e.g., example 74) relates to a target device, comprising means for communicating with one or more controller devices via a bus, and means for controlling configured to emulate clock stretching by providing requests to start and end clock stretching via an in-band interrupt mechanism, e.g., to cause the controller device to pause data or control transmissions to the target apparatus during the emulated clock stretching, and to cause the controller apparatus to resume the data or command transmissions after the emulated clock stretching has ended.

Another example (e.g., example 75) relates to a previous example (e.g., example 74) or to any other example, further comprising that the target device is an I3C target device for an I3C system or a mixed I2C and I3C system.

Another example (e.g., example 76) relates to a previous example (e.g., one of the examples 74 or 75) or to any other example, further comprising that the means for controlling is configured to provide, to indicate the start of clock stretching requested by the target device, a start clock stretching request as an in-band interrupt, and to provide, to indicate the stop of clock stretching requested by the target device, a stop clock stretching request as in-band interrupt.

Another example (e.g., example 77) relates to a previous example (e.g., example 76) or to any other example, further comprising that at least one of the start clock stretching request or the stop clock stretching request comprises a time stamp of when the target device received the last data that triggered the target device to provide the start clock stretching request.

Another example (e.g., example 78) relates to a previous example (e.g., one of the examples 76 or 77) or to any other example, further comprising that at least one of the start clock stretching request or the stop clock stretching request comprises a time stamp of when the target device processed the last data that triggered the device to provide the stop clock stretching request.

Another example (e.g., example 79) relates to a previous example (e.g., one of the examples 74 to 78) or to any other example, further comprising that the start/stop clock stretching requests are transmitted according to the I3C communication protocol.

Another example (e.g., example 80) relates to a previous example (e.g., one of the examples 74 to 79) or to any other example, further comprising that the functionality of the target circuitry is defined by a firmware of the target device.

An example (e.g., example 81) relates to a target device comprising means for communicating with one or more controller devices via a bus, and means for controlling configured to communicate with a controller device via the bus, and to emulate clock stretching by providing a pre-defined data pattern on a data line of the bus.

Another example (e.g., example 82) relates to a previous example (e.g., example 81) or to any other example, further comprising that the target device is an I2C target device for a mixed I2C and I3C system.

Another example (e.g., example 83) relates to a previous example (e.g., one of the examples 81 or 82) or to any other example, further comprising that the means for controlling is configured to provide the pre-defined data pattern after receiving a command or data from a controller device.

Another example (e.g., example 84) relates to a previous example (e.g., one of the examples 81 to 83) or to any other example, further comprising that the means for controlling is configured to emulate clock stretching if the target device is temporarily unable to process or react to data or a command by a controller device.

Another example (e.g., example 85) relates to a previous example (e.g., one of the examples 81 to 84) or to any other example, further comprising that the means for controlling is configured to emulate clock stretching if the target device is used in a mixed I2C and I3C system, and to perform clock stretching if the target device is used in a I2C system.

Another example (e.g., example 86) relates to a previous example (e.g., one of the examples 81 to 85) or to any other example, further comprising that the functionality of the means for controlling is defined by a firmware of the target device.

An example (e.g., example 87) relates to a method for a target device, comprising communicating with a controller device via a bus, and emulating clock stretching by providing requests to start and end clock stretching via an in-band interrupt mechanism, e.g., to cause the controller device to pause data or control transmissions to the target apparatus during the emulated clock stretching, and to cause the controller apparatus to resume the data or command transmissions after the emulated clock stretching has ended.

Another example (e.g., example 88) relates to a previous example (e.g., example 87) or to any other example, further comprising that the method is performed by an I3C target device for an I3C system or a mixed I2C and I3C system.

Another example (e.g., example 89) relates to a previous example (e.g., one of the examples 87 or 88) or to any other example, further comprising that the method comprises providing, to indicate the start of clock stretching requested by the target device, a start clock stretching request as an in-band interrupt, and providing, to indicate the stop of clock stretching requested by the target device, a stop clock stretching request as in-band interrupt.

Another example (e.g., example 90) relates to a previous example (e.g., example 89) or to any other example, further comprising that at least one of the start clock stretching request or the stop clock stretching request comprises a time stamp of when the target device received the last data that triggered the target device to provide the start clock stretching request.

Another example (e.g., example 91) relates to a previous example (e.g., one of the examples 89 or 90) or to any other example, further comprising that at least one of the start clock stretching request or the stop clock stretching request comprises a time stamp of when the target device processed the last data that triggered the device to provide the stop clock stretching request.

Another example (e.g., example 92) relates to a previous example (e.g., one of the examples 87 to 91) or to any other example, further comprising that the start/stop clock stretching requests are transmitted according to the I3C communication protocol.

Another example (e.g., example 93) relates to a previous example (e.g., one of the examples 87 to 92) or to any other example, further comprising that the method is performed by a firmware of the target device.

An example (e.g., example 94) relates to a method for a target device, comprising communicating with a controller device via a bus, and emulating clock stretching by providing a pre-defined data pattern on a data line of the bus.

Another example (e.g., example 95) relates to a previous example (e.g., example 94) or to any other example, further comprising that the target device is an I2C target device for a mixed I2C and I3C system.

Another example (e.g., example 96) relates to a previous example (e.g., one of the examples 94 or 95) or to any other example, further comprising that the method comprises providing the pre-defined data pattern after receiving a command or data from a controller device.

Another example (e.g., example 97) relates to a previous example (e.g., one of the examples 94 to 96) or to any other example, further comprising that the method comprises emulate clock stretching if the target device is temporarily unable to process or react to data or a command by a controller device.

Another example (e.g., example 98) relates to a previous example (e.g., one of the examples 94 to 97) or to any other example, further comprising that the method comprises emulating clock stretching if the target device is used in a mixed I2C and I3C system, and to perform clock stretching if the target device is used in a I2C system.

Another example (e.g., example 99) relates to a previous example (e.g., one of the examples 94 to 98) or to any other example, further comprising that the method is performed by a firmware of the target device.

Another example (e.g., example 100) relates to a non-transitory machine-readable storage medium including program code, when executed, to cause a machine to perform the method of one of the examples 35 to 45, the method of one of the examples 87 to 93, or the method of one of the examples 94 to 99.

Another example (e.g., example 101) relates to a computer program having a program code for performing the method of one of the examples 35 to 45, the method of one of the examples 87 to 93, or the method of one of the examples 94 to 99 when the computer program is executed on a computer, a processor, or a programmable hardware component.

Another example (e.g., example 102) relates to a machine-readable storage including machine readable instructions, when executed, to implement a method or realize an apparatus as claimed in any pending claim.

An example (e.g., example 103) relates to an apparatus configured to emulate clock stretching in firmware by sending in-band interrupts indicating to hold data patterns according to specific data patterns.

Another example (e.g., example 104) relates to a previous example (e.g., example 103) or to any other example, further comprising that the apparatus is suitable for use in I3C systems.

Another example (e.g., example 105) relates to a system comprising one or more controller apparatuses or controller devices according to one of the examples 1 to 34 (or according to any other example) and one or more target apparatuses or target devices according to one of the examples 46 to 93 (or according to any other example).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components.

Examples may also cover program storage devices, such as digital data storage media, which are machine-, processor- or computer-readable and encode and/or contain machine-executable, processor-executable or computer-executable programs and instructions.

Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A controller apparatus, comprising interface circuitry for communicating with one or more target apparatuses via a bus, and control circuitry configured to:
communicate with a target apparatus via the bus,
emulate clock stretching based on requests to start and end clock stretching obtained via an in-band interrupt mechanism, wherein the control circuitry is configured to pause data or command transmissions to the target apparatus during the emulated clock stretching, and to resume the data or command transmissions to the target apparatus after the emulated clock stretching has ended.

2. The controller apparatus according to claim 1, wherein the controller apparatus is a controller apparatus for an I3C system.

3. The controller apparatus according to claim 1, wherein the control circuitry is configured to receive, from a target apparatus, a start clock stretching request as an in-band interrupt, the request indicating the start of clock stretching requested by the target apparatus and receive, from the target apparatus, a stop clock stretching request as an in-band interrupt, the stop clock stretching request indicating the stop of clock stretching requested by the target apparatus.

4. The controller apparatus according to claim 3, wherein the control circuitry is configured to pause data or command transmissions to the target apparatus in response to the start clock stretching request, and resume data or command transmissions to the target apparatus in response to the stop clock stretching request.

5. The controller apparatus according to claim 1, wherein the control circuitry is configured to emulate clock stretching for I3C target apparatuses based on the requests to start and end clock stretching obtained via the in-band interrupt mechanism.

6. The controller apparatus according to claim 5, wherein the control circuitry is further configured to emulate clock stretching for I2C target apparatuses by detecting, on a data line, a pre-defined data pattern representing a request of a target apparatus to perform clock stretching.

7. The controller apparatus according to claim 6, wherein the control circuitry is configured to pause data or command transmissions to the target apparatus in response to the pre-defined data pattern for a defined time period.

8. The controller apparatus according to claim 7, wherein the control circuitry is configured to detect the pre-defined data pattern after providing a command or data for the target apparatus.

9. The controller apparatus according to claim 7, wherein the control circuitry is configured to repeat providing the command or data for the target apparatus after the defined time period.

10. The controller apparatus according to claim 7, wherein the control circuitry is configured to determine the defined time period to use for a target apparatus based on previous pre-defined data patterns detected from the target apparatus.

11. The controller apparatus according to claim 1, wherein the functionality of the control circuitry is defined by a firmware of the controller apparatus.

12. A target apparatus, comprising interface circuitry for communicating with one or more controller apparatuses via a bus, and control circuitry configured to:
communicate with a controller apparatus via the bus; and
emulate clock stretching by providing requests to start and end clock stretching via an in-band interrupt mechanism, to cause the controller apparatus to pause data or control transmissions to the target apparatus during the emulated clock stretching, and to cause the controller apparatus to resume the data or command transmissions after the emulated clock stretching has ended.

13. The target apparatus according to claim 12, wherein the target apparatus is an I3C target apparatus for an I3C system or a mixed I2C and I3C system.

14. The target apparatus according to claim 12, wherein the control circuitry is configured to provide, to indicate the start of clock stretching requested by the target apparatus, a start clock stretching request as an in-band interrupt, and to provide, to indicate the stop of clock stretching requested by the target apparatus, a stop clock stretching request as in-band interrupt.

15. The target apparatus according to claim 12, wherein the requests are transmitted according to the I3C communication protocol.

16. The target apparatus according to claim 12, wherein the functionality of the target circuitry is defined by a firmware of the target apparatus.

17. A target apparatus comprising interface circuitry for communicating with one or more controller apparatuses via a bus, and control circuitry configured to:
communicate with a controller apparatus via the bus; and
emulate clock stretching by providing a pre-defined data pattern on a data line.

18. The target apparatus according to claim 17, wherein the target apparatus is an I2C target apparatus for a mixed I2C and I3C system.

19. The target apparatus according to claim 17, wherein the control circuitry is configured to provide the pre-defined data pattern after receiving a command or data from a controller apparatus.

20. The target apparatus according to claim 17, wherein the control circuitry is configured to emulate clock stretching if the target apparatus is used in a mixed I2C and I3C system, and to perform clock stretching if the target apparatus is used in a I2C system.
